(19) United States
(12) Patent Application Publication
(10) Pub. No.: US 2018/0072174 A1
(43) Pub. Date: Mar. 15, 2018

(54) Drive-Over Protection for Cables for an Inductive Charging Coil for Electric Vehicles

(71) Applicant: Bayerische Motoren Werke Aktiengesellschaft, Muenchen (DE)

(72) Inventors: Josef KRAMMER, Holzkirchen (DE); Mathias LACHMUND, Feldafing (DE)

(21) Appl. No.: 15/814,518

(22) Filed: Nov. 16, 2017

Related U.S. Application Data
(63) Continuation of application No. PCT/EP2016/061816, filed on May 25, 2016.

(30) Foreign Application Priority Data
May 26, 2015 (DE) 10 2015 209 576.2

(51) Int. Cl. B60L 11/18

(52) U.S. Cl. CPC B60L 11/1831; B60L 2230/12; B60L 11/182; B60L 11/1818

(57) ABSTRACT

A primary coil unit for an inductive charging system is provided. The primary coil unit includes a primary coil, a control unit, a housing and an electric supply cable. The primary coil includes a cable duct for the supply cable. The cable duct can be connected to the housing in order to establish a duct-housing connection. The control unit is configured to electrically monitor the duct-housing connection.

### CROSS REFERENCE TO RELATED APPLICATIONS

This application is a continuation of PCT International Application No. PCT/EP2016/061816, filed May 25, 2016, which claims priority under 35 U.S.C. § 119 from German Patent Application No. 10 2015 209 576.2, filed May 26, 2015, the entire disclosures of which are herein expressly incorporated by reference.

### BACKGROUND AND SUMMARY OF THE INVENTION

The invention relates to a primary coil unit for an inductive charging system, wherein the primary coil unit includes a primary coil, a control unit, a housing and an electric supply cable.

The invention is in the field of inductive charging of a rechargeable battery of a vehicle. Vehicles, in particular vehicles with electric drive, include rechargeable batteries for storing electrical energy. One approach to automatically, wirelessly and inductively charge the battery of a vehicle involves electrical energy being transmitted from the vehicle-external ground to the underbody of the vehicle via magnetic induction for charging the battery, bridging the vehicle underbody clearance. The vehicle includes a secondary coil in the region of the vehicle underbody, and a primary coil unit is located outside of the vehicle, relative to which the vehicle with the secondary coil must be positioned for charging. The primary coil unit can also be referred to as a base unit or ground unit, as the primary coil unit is connected in a suitable manner to the ground below the vehicle, such as a parking space, see e.g., document DE 10 2007 033 654 A1.

A high charging efficiency can only be achieved if the secondary coil is precisely positioned relative to the primary coil unit for charging, i.e., in the accuracy range of a few centimeters. According to document DE 10 2012 216 660 A1, the user of the vehicle is assisted by way of technical methods when parking, in order to achieve this exact positioning.

In the case of simple inductive charging systems, the user is able to install the primary coil unit him/herself, e.g., near to parking spaces around the home. In the prior art, different possibilities for the mechanical fastening of the primary coil unit to the ground are described, see for example DE 10 2013 221 648 A1.

An object of the invention is to specify an improved primary coil unit for an inductive charging system, wherein the primary coil unit includes a primary coil, a control unit, a housing and an electrical supply cable. In particular, an object of the invention is to enable a reliable home-based installation of a primary coil unit.

This and other objects are achieved by a primary coil unit for an inductive charging system, according to embodiments of the invention.

According to an embodiment of the invention, the primary coil includes a cable duct for the supply cable, wherein the cable duct can be connected to the housing to produce a duct-housing connection, and wherein the control unit is configured to electrically monitor the duct-housing connection.

With the primary coil unit installed, the supply cable of the primary coil runs in the cable duct, which is mounted on the housing of the primary coil unit. When the cable duct is correctly mounted on the housing and the supply cable is correctly mounted on the primary coil, the supply cable can run only within the cable duct. This is guaranteed by the fact that otherwise, a connection of the supply cable to the cable duct is not possible, because the cable duct surrounds the cable in the manner of a heat-shrink tube. If the cable is therefore not enclosed by the cable duct, then either the cable duct cannot be attached to the housing or the cable cannot be attached to the primary coil. The control unit allows the duct-housing connection to be electrically detectable. This can be implemented by having the control electronics of the primary coil detect, by way of a switch, whether the duct is snapped into the primary coil. As an alternative to a switch, a Hall element with a magnetic element on the duct can be used for detecting whether a duct is connected. In addition, the control unit can be used to detect the connection of the cable to the primary coil.

According to a preferred variant of the invention, an inductive charging system includes such a primary coil unit and a secondary coil, which can be integrated into a vehicle.

The primary coil unit according to an embodiment of the invention can therefore be part of an inductive charging system, which also includes a secondary coil that can be integrated into a vehicle.

It is also advantageous if this vehicle is equipped with a secondary coil of such an inductive charging system, and the vehicle or the inductive charging system includes a determining device, by way of which the relative spatial position of the primary coil unit to the secondary coil can be determined.

The determining device for determining the position can be radio antenna systems, which operate according to the principle of triangulation. For example, the vehicle or the secondary coil can include two transmitting antennas which each broadcast a defined electromagnetic positioning signal. Two receivers can be located in the region of the primary coil in order to detect the magnitude and direction, e.g., of the magnetic field vector of the respective broadcast signals. Based on the detected field strength, the relative position of the primary coil to the secondary coil can be determined.

According to a particularly preferred embodiment of the invention, for the inductive transmission of energy from the primary coil to the secondary coil, the vehicle can be positioned in a predefined charging position relative to the primary coil unit, and in the charging position the longitudinal direction of the vehicle is arranged substantially parallel to the orientation of the cable duct, and the length of the cable duct is at least greater than the distance from the secondary coil to the vehicle axle nearest to the secondary coil, measured in the longitudinal direction of the vehicle.

This means that in the specified charging position of the vehicle, the cable duct occupies a specific minimum length in the x-direction relative to the vehicle. The cable inside the cable duct is routed away from the primary coil unit by at least this length.

According to a further variant of the invention, in order for the vehicle to reach the charging position, the spatial position of the primary coil unit relative to the secondary coil can be determined by the determining device. The vehicle includes a display device, which can indicate when the primary coil occupies such a relative spatial position to the secondary coil, starting from which the charging position can only be reached by way of a driving maneuver with more than one move.

This ensures that the cable duct, and therefore the supply cable, are effectively protected against being driven over by a wheel of the vehicle. The length of the cable duct in relation to the position of the secondary coil in the region of the underbody of the vehicle concerned also ensures that a free part of the supply cable, not located in the cable duct, is also protected against being driven over. As a result of the length of the cable duct, such a cable is routed out of the cable duct from the side of the primary coil facing away from the cable duct, so far away from the axle of the vehicle that the cable can only be driven over if the cable is “routed back” outside of the cable duct in the direction of the primary coil. In addition, due to the position determination of the secondary coil relative to the primary coil, as the vehicle is approaching the charging position, it is possible to indicate to the user when the charging position cannot be reached in one move, i.e., in a single driving maneuver in forward gear by movement of the steering wheel. This is designed to prevent the vehicle user from maneuvering in the area of the primary coil unit and to ensure an early maneuvering operation with the initiation of a repeated approach to the primary coil. Maneuvering in the area of the primary coil carries an increased risk of driving over the cable duct and/or the free cable end which emerges from the cable duct.

Overall, the length of the cable duct in relation to the installation space of the secondary coil in the area of the underbody of the vehicle and the predefined charging position, in conjunction with the assisted occupation of the charging position in forward gear in one move, reduce the probability that the cable duct itself, or the end of the supply cable coming from the cable duct which faces away from the primary coil, is driven over by a wheel of the vehicle. In this way, the level of wear on the primary coil unit is very effectively reduced and the reliability of the primary coil unit is increased.

The invention is based on the following considerations:

In the inductive charging of PHEV and BEV vehicles, an inductive charging system is apparently becoming established in which energy is inductively transferred from a primary coil on the ground to a secondary coil on the underbody of the vehicle. To implement such systems in the most cost-effective way in the range of low charging powers, there are approaches to the solution which can integrate the complete primary-side control electronics into the primary coil. This enables a simple connection of the system to a power outlet via a standard domestic power plug. The installation costs are therefore very low. A change of charging location, e.g., if the user moves to a different house or sells the vehicle to a different user, is also possible with minimal relocation effort of the primary side.

Since no electrical engineering knowledge is required to install the primary side on the standard household power supply, this allows installation without an electrical engineering expert, or by a lay person without any electrotechnical knowledge. If the primary coil is installed by a lay person, it is not straightforward to ensure that all safety aspects are strictly observed. Thus, for example, the connection cable could be routed such that repeated driving over the connection cable when reversing into and out of the parking causes damage to the cable. This leads to premature wear of the cable. In the extreme case, there may be a risk of an electric shock to the user or to other persons who happen to be in the area of the connection cable. This would apply regardless of whether charging is taking place or not.

Measures are proposed that ensure a safe routing of the connecting cable. A driveover-safe cable duct is attached to the primary coil. The design is implemented such that the connecting cable must be routed through the cable duct. In addition, a sensor monitors whether the cable duct is connected. If this is not the case, charging is prevented and a corresponding error display on the primary coil or in the vehicle indicates the incorrect installation. In addition, to assist in approaching the charging location, i.e., where the primary coil is mounted, and to monitor the relative position of the vehicle to the primary coil, a relative position determination is carried out, which starts as early as a few meters before reaching the target position. Using this position determination of the inductive charging system, on approaching the parking position it is monitored whether the area in which driving over the connecting cable is possible, is avoided. The primary coil contains information on the orientation of the charging cable and the vehicle contains the information on the position of the secondary coil on the vehicle. This enables an area to be determined, which can lead to driving over the cable or cable duct during the parking operation. This will be displayed to the operator and optionally, the charging can be prevented as a result. This means that before operating the primary coil, the operator is forced to correctly install the primary coil with the connection cable.

Both of these measures in combination ensure a correct installation and a correct operation of the inductive charging system, which can be installed by a lay person without any electrotechnical knowledge. This enables both a low level of wear on the system and a safe installation for the user and third parties.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of an inductive charging system and occupation of a charging position by a vehicle.

### DETAILED DESCRIPTION OF THE DRAWINGS

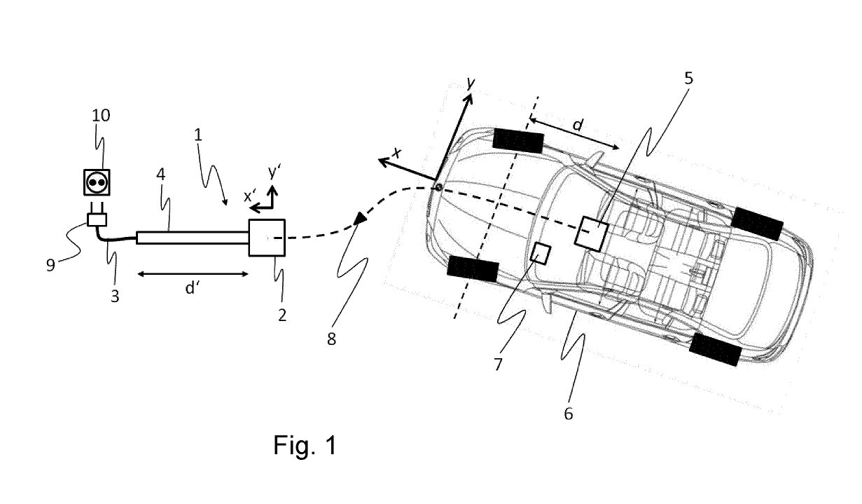

FIG. 1 shows a primary coil unit 1 of an inductive charging system. The primary coil unit 1 includes a primary coil 2, a housing of the primary coil, and a supply cable 3 for the primary coil 2. The primary coil unit 1 is suitable for installation by a user in the home setting. Possible locations are the floor area of a domestic garage or a domestic parking space. The design of the primary coil unit 1 and the use of the primary coil unit 1 are intended to enable a professional and reliable installation for the inductive charging operation.

This is achieved by use of a cable duct 4. The supply cable 3 must be routed through the cable duct 4. One end of the supply cable 3 faces towards the primary coil 2, the other end has a plug connector 9, which can be designed as e.g., a Schuko plug, to a 230 volt Schuko outlet 10.

Furthermore, the primary coil unit 1 has a control device. The control device can be used to monitor whether the cable duct 4 is connected to the housing. This can be effected by a monitoring circuit that is opened if the cable duct 4 is not properly connected to the housing. In this state, a charging operation of the inductive charging system is prevented by the control unit. A charging operation is only possible if the supply cable 3 is connected to the primary coil 2 anyway. A connection of the supply cable 3 to the primary coil 2 with a properly made connection between the cable duct 4 and the housing is only possible if the cable is routed within the cable duct 4. If the cable is routed outside of the cable duct 4, the cable would be crushed by the cable duct-housing connection, or due to the thickness of the cable and the tight fit of the cable duct-housing connection, such a crushing is not possible without destroying the cable.

When properly installed, the cable duct 4 points in the direction x′. It has the length d′.

In a vehicle 6, a secondary coil 5 is integrated in the area of the underbody. The primary coil unit 1 and the secondary coil 5 form an inductive charging system, with which a high-voltage battery of the vehicle 6 can be charged in a contactless manner.

For inductive charging, the vehicle 6 must occupy a charging position relative to the primary coil unit 1 in which the secondary coil 5 and the primary coil 2 are facing each other with the minimum possible offset in the x and y direction. Here, the x-direction designates the longitudinal axis of the vehicle 6 and the y-direction the transverse axis of the vehicle 6.

The vehicle 6 has radio transmitters or receivers that correspond to radio receivers or transmitters of the primary coil unit 1. By way of this radio system, data can be exchanged between a control unit of the vehicle 6 and the control unit of the primary coil unit 1. In particular, the position of the vehicle 6, and therefore of the secondary coil 5 relative to the primary coil unit 1, is determined by way of the radio system. This position determination can be performed in real time while the vehicle 6 is approaching the primary coil unit 1. In detail, the position is determined by triangulation, by an electromagnetic field vector at the receiving location being measured in relation to its direction and magnitude, and on the basis of the measurement the relative position of the transmitter and receiver is then calculated. The calculation is carried out by a control unit on the vehicle 6. The position determination is used as the main input variable for calculating a driving trajectory 8 in forward gear from the currently determined position of the vehicle 6 into the charging position. The charging position is indicated by the end point of the trajectory 8 indicated by the arrow in FIG. 1.

The driving trajectory 8 can be displayed to the vehicle driver by using a display device 7. In addition, the turning circle properties of the vehicle 6 are stored in the control unit. On the basis of the turning circle properties, the control unit determines whether the vehicle 6 can follow the trajectory 8. If the trajectory 8 cannot be driven by the vehicle 6, this is also displayed to the driver, e.g., with a signal on the instrument panel. At the same time, the driver is prompted to remove the vehicle 6 from the primary coil unit 1 and to make a new approach to the charging position.

This will prevent the user from possibly having to make even more than one maneuver in the area of the primary coil unit in order to reach the charging position.

This will prevent the cable duct 4, or even the cable emerging from the opposite end of the cable duct 4 to the primary coil 2, from being driven over by the vehicle 6 unnecessarily when occupying the charging position. The primary coil unit 1, installable by a lay person using simple resources, in which various components are exposed in the ground area in the installed state, thus obtains an effective service life extension and a high level of system safety is ensured in operation. The supply cable 3 is protected against being driven over in particular due to the fact that the distance d of the secondary coil 5 in the direction of the front axle (indicated by the dashed line parallel to the y-direction in FIG. 1) is smaller than the length d′ of the cable duct 4. Thus when the charging position is occupied the free portion of the supply cable 3 is routed by the cable duct 4 so far away from the primary coil 2 that the cable must be routed back along the cable duct 4 and outside of the cable duct 4 in the direction of the primary coil 2 in order to enter a region which is accessible by the edges of the vehicle 6.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A primary coil unit for an inductive charging system, comprising:
a primary coil;
a control unit;
a housing; and
an electrical supply cable, wherein
the primary coil includes a cable duct for the supply cable,
the cable duct is connectable to the housing to produce a duct-housing connection, and
the control unit is configured to electrically monitor the duct-housing connection.

2. An inductive charging system, comprising:
a primary coil unit including:
a primary coil;
a control unit;
a housing; and
an electrical supply cable, wherein
the primary coil includes a cable duct for the supply cable,
the cable duct is connectable to the housing to produce a duct-housing connection, and
the control unit is configured to electrically monitor the duct-housing connection; and
a secondary coil, which is integratable into a vehicle.

3. A vehicle comprising:
the inductive charging system including the secondary coil, according to claim 2, wherein
the vehicle or the inductive charging system includes a determining device, by way of which a spatial position of the primary coil unit relative to the secondary coil is determined.

4. The vehicle according to claim 3, wherein
for inductive transmission of energy from the primary coil to the secondary coil, the vehicle is positionable in a specified charging position relative to the primary coil unit,
in the charging position, a longitudinal direction of the vehicle is arranged substantially parallel to an orientation of the cable duct, and
a length of the cable duct is at least greater than a distance from the secondary coil to a vehicle axle which is nearest to the secondary coil, measured in the longitudinal direction of the vehicle.

5. The vehicle according to claim 4, wherein
in order for the vehicle to reach the charging position, the determining device determines the spatial position of the primary coil unit relative to the secondary coil, and
the vehicle further comprises a display device, wherein
the display device produces an indication when the primary coil occupies the spatial position relative to the secondary coil, starting from which the charging position can only be reached by way of a driving maneuver with more than one move.
